(19) United States
(12) Patent Application Publication
(10) Pub. No.: US 2016/0257875 A1
(43) Pub. Date: Sep. 8, 2016

(54) GRANULATED INORGANIC PARTICULATES AND THEIR USE IN OILFIELD APPLICATIONS

(71) Applicant: Imerys Oilfield Minerals, Inc., Roswell, GA (US)

(72) Inventors: MARK WINDEBANK, PAR CORNWALL (GB); JONATHAN PHIPPS, CORNWALL (GB); THOMAS PARIAS, RHODE-SAINT-GENESE (BE); ROGER WILLIAMS, ROSWELL, GA (US); DAVID GUETTA, PARIS (FR)

(21) Appl. No.: 15/153,206

(22) Filed: May 12, 2016

Related U.S. Application Data
(62) Division of application No. 14/362,962, filed on Jun. 5, 2014.
(60) Provisional application No. 61/586,224, filed on Jan. 13, 2012.

(30) Foreign Application Priority Data
Dec. 6, 2011 (EP) 11290562.5

(51) Int. Cl. C09K 8/80; E21B 43/267; E21B 43/26; C09K 8/62

(52) U.S. Cl. CPC C09K 8/80; C09K 8/62; E21B 43/267; E21B 43/26

(57) ABSTRACT

Disclosed herein are granulated inorganic particulate compositions exhibiting at least one property chosen from improved material handling, low dusting, easy make-down in to mineral-water slurry, and requiring lets energy to produce than spray dried inorganic particulate products. In one embodiment, the granulated inorganic particulate compositions are characterized by a moisture content ranging from 2% to 60% by weight relative to the total weight of the composition, such as for example from 2% to 10% or from 30 to 50%. In another embodiment, the granulated inorganic particulate compositions have an average granule size of greater than about 10 mesh. In a further embodiment, the granulated inorganic particulate composition comprises granules of inorganic particulate that are friable when subjected to a shear force. The granulated inorganic particulate may take on any shape, ranging from and including but not limited to very angular, to sub-rounded, to approximately spherical (i.e., having a Krumbein sphericity of at least about 0.8).

### CLAIM FOR PRIORITY

This PCT International Application claims the benefit of priority of U.S. Provisional Patent Application No. 61/586,224, filed Jan. 13, 2012, and European Patent Application No. 11290562.5, flied Dec. 6, 2011, the subject matter of both of which is incorporated herein by reference in their entireties.

### FIELD OF THE DISCLOSURE

The present invention relates to water-dispersible granulated inorganic particulates for use in hydraulic fracturing and oil well applications (e.g., proppants, weighting agents, lubricants, fluid loss prevention agents, etc.), and to a method for production of such granules.

### BACKGROUND OF THE DISCLOSURE

Naturally occurring deposits containing oil and natural gas have been located throughout the world. Given the porous and permeable nature of the subterranean structure, it is possible to bore into the earth and set up a well where oil and natural gas are pumped out of the deposit. These wells are large, costly structures that are typically fixed at one location. As is often the case, a well may initially be very productive, with the oil and natural gas being pumpable with relative ease. As the oil or natural gas near the well bore is removed from the deposit, other oil and natural gas may flow to the area near the well bore so that it may be pumped as well. However, as a well ages, and sometimes merely as a consequence of the subterranean geology surrounding the well bore, the more remote oil and natural gas may have difficulty flowing to the well bore, thereby reducing the productivity of the well.

To address this problem and to increase the flow of oil and natural gas to the well bore, companies have employed the well-known technique of fracturing the subterranean area around the well to create more paths for the oil and natural gas to flow toward the well. As described in more detail in the literature, this fracturing is accomplished by hydraulically injecting a fluid at very high pressure into the area surrounding the well bore. This fluid can then be removed from the fracture to the extent possible to ensure that it does not impede the flow of oil or natural gas back to the well bore. Once the fluid is removed, the fractures have a tendency to collapse due to the high compaction pressures experienced at well-depths, which can be more than 20,000 feet. To prevent the fractures from dosing, it is well-known to include a propping agent, also known as a proppant, in the fracturing fluid. The goal is to be able to remove as much of the injection fluid as possible while leaving the proppant behind to keep the fractures open.

Several properties affect the performance of a proppant. If forces in a fracture are too high for a given proppant, the proppant will crush and collapse, and then no longer have a sufficient permeability to allow the proper flow of oil or natural gas. In deep wells or wells whose formation forces are high, proppants can be capable of withstanding high compressive forces, often greater than 10,000 pounds per square inch (“psi”). Proppants able to withstand these forces (e.g., up to and greater than 10,000 psi) are referred to as high strength proppants. In shallower wells, high strength proppants may not be necessary as intermediate strength proppants may suffice. Intermediate strength proppants are typically used where the compressive forces are between 5,000 and 10,000 psi. Still other proppants can be used when the compressive forces are low. For example, sand is often used as a proppant at low compressive forces.

In addition to the strength of the proppant, size of proppant important. Productivity in new shale formations can be enhanced with very fine proppants. See for example PCT patent WO2010021563A1 to Schlumberger. For example mica particles with an average plate thickness ranging from 1 micron to 500 microns are described in WO2010021563A1 as suitable for use in propping very fine fractures.

One drawback with the use of the fine mica in oilfield applications is the poor material characteristics of the dry mica particles. Proppants often fed into the fracture fluid on-site using high speed conveyor belts. Very fine materials tend to be too fluffy to convey on these high speed conveyors, and can escape via wind etc. Further, due to the poor flow characteristics of the material it can be difficult to discharge the material from delivery trucks or stationary silos as the fine particles tend to form bridges in silos and handling systems, particularly in presence of moisture.

The same problems as described above in connection with mica also goes for other relatively fine inorganic particulate materials that might be used in fracturing fluid and oil well applications as proppants or other additives for drilling and fracturing fluids, such as for example graphite which can be used as a lubricant or fluid loss prevention agent.

Fine dry powders like this will have the ability to behave dusty and have a negative impact on the environment during handling in open air. It may lead to a potential health hazardous situations for the workers.

To overcome these problems it has been a desire to convert the powdery materials to a particulate agglomerated or granulated powder that gives the required material handling and flow characteristics, as well as reduced dusting.

Agglomeration of the mica particles and other powdery inorganic particulates to form granules can in principle be done by a number of methods such as briquetting and compaction processes as well various ways of making pellets, spray dried granules or fluidised bed dried products and use of inorganic or organic substances as binding aids.

In some cases, the use of granulated powdery inorganic particles in well drilling applications can be facilitated by use of binders that make it possible to redisperse the granulated particles in a water or an oil phase. Redispersion means that the granulates upon dispersion in water or oil are broken down into the original particles. Further, the binders used may be compatible with the well drilling composition.

Handling of the granules after processing, through bagging units, storage and transport handling, transfer by use of blowers into silos, compaction due to its weight in a silo, activated with fluidisation, feeding screws, etc. may result in a too early disintegration of the granules thereby causing silo blockages or feeding problems if the granules do not have sufficient strength.

On the one hand: the granules may be stable enough to survive all such handling without disintegration. On the other hand: the granules may be able to easily disintegrate under low shear stress in the liquid application suspension and in dry applications.

Since well drilling takes place in an open natural environment by humans, any substances used shall also comply with environmental and safety regulations for use of chemical substances in the nature and by workers.

These above-mentioned requirements set strict limitations to binding additives and other chemical substances to be used for the production of the handling-stable, but easy dispersible granules.

### SUMMARY OF THE DISCLOSURE

Disclosed herein are granulated inorganic particulate compositions exhibiting at least one property chosen from improved material handling, low dusting, easy make-down in to mineral-water slurry, and requiring less energy to produce than spray dried inorganic particulate products. In one embodiment, the granulated inorganic particulate compositions are characterized by a moisture content ranging from 2% to 60% by weight relative to the total weight of the composition, such as for example from 2% to 10% or from 30% to 50%. In another embodiment, the granulated inorganic particulate compositions have an average granule size of greater than about 10 mesh. In a further embodiment, the granulated inorganic particulate composition comprises granules of inorganic particulate that are friable when subjected to a shear force. The granulated inorganic particulate may take on any shape, ranging from and including but not limited to very angular, to sub-rounded, to approximately spherical (i.e., having a Krumbein sphericity of at least about 0.8).

Also disclosed herein is a granulated inorganic particulate composition for use in oil field applications comprising: a Inorganic particulate having an average particle size less than about 20 mesh; 0.01% to about 1.0% of a water soluble binder; wherein said granulated inorganic particulate composition has a granule size greater than about 20 mesh.

Also disclosed herein is a granulated inorganic particulate composition for use in oil field applications comprising: a inorganic particulate having an average particle size less than about 12 mesh; 0.01% to about 1.0% of a water soluble binder, wherein said granulated inorganic particulate composition has a granule size greater than about 12 mesh.

Also disclosed herein is a granulated inorganic particulate composition for use in oil field applications comprising: a inorganic particulate having an average particle size ranging generally from about 20 mesh to about 500 mesh; 0.01% to about 1.0% of a water soluble binder; wherein said granulated inorganic particulate composition has a granule size ranging from about 5 mesh to about 20 mesh.

Also disclosed herein is a granulated inorganic particulate composition for use in oil field applications comprising: a inorganic particulate having a median particle size (d50) ranging generally from about 1 micron to about 50 microns (by CILAS); 0.01% to about 1.0% of a water soluble binder; wherein said granulated inorganic particulate composition has a granule size ranging from about 5 mesh to about 20 mesh.

In one aspect, the inorganic particulate comprises a rock or mineral powder, e.g. a material selected from silica sand (e.g. silica flour, Ottawa sand, etc.), bauxite, andalusite, alumina, barite, or talc. In another aspect, the granulated inorganic particulate comprises ceramic, porcelain, earthenware, stoneware, brick, glass (e.g., cullet), fly-ash, or slag.

In another aspect, the granulated inorganic particulate comprises mica. In another aspect, the granulated inorganic particulate comprises a plate like mineral. In yet another aspect, the granulated inorganic particulate comprises a plate like mineral is selected schist, shale (mudstone), phyllosilicates (sheet silicates), glauconite, kaolinite, smectite, pyrophyllite, phengite, montmorillonite, saponite, vermiculite, hectorite, sepiolite, palygorskite (attapulgite), and laponite, a sodium silicate hydrates (such as kanemite, grumantite, revdite, makatite, magadiite, kenyaite, and octosilicate), a serpentine mineral (such as antigorite, chrysotile, lizardite, and chrysotile), chlorite, talc, inosilicates, pyroxenoid minerals (such as wollastonite, and rhodonite), amphibole minerals (such as anthophyllite, tremolite, actinolite, grunerite, amosite, homblende, and diopside), silica, flint (chert), novaculite, kyanite, zeolites (aluminosilicates), hydrotalcite, minerals of the sjogrenite-hydrotalcite group (carbonates), wulfenite (sulfates), asphalts (such as asphalt mesophases), and graphite.

In another aspect, the granulated inorganic particulate can comprise a blend of two or more of any of the aforementioned materials.

In another aspect, the granulated inorganic particulate has an average particle size ranging from about 20 to 500 mesh, such as for example from about 20 mesh to about 325 mesh, or from about 40 mesh to about 140 mesh. In another aspect, the inorganic particulate has a median particle size (d50) ranging from about 1 micron to about 50 microns a as measured by CILAS, such as for example from 5 microns to 15 microns.

In another aspect, the granulated inorganic particulate has a binder content ranging from about 0.1% to about 0.5%. In yet another aspect, the granulated inorganic particulate composition has a binder content ranging from about 0.5% to about 25% (especially when the binder comprises guar gum). In one aspect, the binder comprises a material selected from hydroxy ethyl cellulose, alginates, guar gum, polyvinyl alcohol, polyvinyl pyrrolidone, and bentonites. In another aspect, the binder comprises carboxymethyl cellulose.

In yet another aspect, the granulated inorganic particulate has a moisture content ranging from about 5% to about 25%. In another aspect the granulated inorganic particulate has an angle of repose ranging from about 15 to about 25 degrees. In yet another aspect, the granulated inorganic particulate has a packed bulk density ranging from about 0.5 g/cm3 to about 1.5 g/cm³.

In yet another aspect, the granulated inorganic particulate has an average particle size of greater than about 12 mesh, such as for example greater than about 10 mesh, greater than about 7 mesh, or ranging from about 7 mesh to about 10 mesh.

In another aspect, the granulated inorganic particulate composition is friable when subjected to a shear force. In another aspect, the granulated inorganic particulate composition is not friable when subjected to a shear force.

In another aspect, the granulated inorganic particulate optionally comprises a dispersant. In one aspect, the optional dispersant is selected from: sodium polyacrylate; soda ash; and condensed phosphates such as tetra-sodium pyrophosphate, sodium hexametaphosphate, and sodium tripolyphosphate.

Further disclosed herein is a granulated mica composition comprising: mica having an average particle size ranging generally from about 20 mesh to about 325 mesh; 0.01% to about 1.0% of a water soluble binder; wherein said granulated mica composition has a granule size ranging from about 5 mesh to about 20 mesh.

Further disclosed herein is a method for producing a granulated inorganic particulate composition, comprising: (a) mixing at least inorganic particulate having an average particle size of less than about 20 microns with water and at least one binder; and (b) agglomerating the resulting mixture to form a granulated inorganic particulate having an average particle size of greater than about 20 mesh.

In one aspect the mixing step and optionally the agglomerating step occurs in a mixer chosen from a low shear mixer and a high shear mixer. In another aspect, the low shear mixer is chosen from a slow speed paddle mixer and a tumblers. In another aspect, the high shear mixer is chosen from a turbolizer, a pin mixer, and a plow-shear mixer.

In another aspect, the agglomerating occurs in a pelletizer chosen from an extruder, a pan pelletizer, a disc pelletizer, a cone pelletizer, and a drum pelletizer.

In another aspect, method for producing a granulated inorganic particulate further comprises screening the granules to remove fine particles having a size smaller than 10 mesh. In another aspect, the method includes recycling the fine particles by adding them to at least one of the mixing step and the agglomerating step.

In another aspect, method for producing a granulated inorganic particulate the process is chosen from a continuous process and a semi-batch process. In another aspect, the method for producing a granulated inorganic particulate further includes drying the granules to remove at least a portion of the water therefrom.

Further disclosed herein is a method for treating a subterranean formation comprising: providing a granulated inorganic particulate composition having an average granule size of at least about 20 mesh, admixing the granulated inorganic particle composition into a fluid, such that the inorganic particulate is dispersed into the fluid as a suspended inorganic particulate, and injecting the fluid and suspended inorganic particulate into the subterranean formation. In one aspect, the method can also include depositing the suspended particulate into a fracture in the subterranean formation.

### DESCRIPTION OF EXEMPLARY EMBODIMENTS

Reference will now be made in more detail to a number of exemplary embodiments of the invention.

In the following description, certain aspects and embodiments will become evident. It should be understood that the aspects and embodiments, in their broadest sense, could be practiced without having one or more features of these aspects and embodiments. Thus, it should be understood that these aspects and embodiments are merely exemplary.

### Granulated Inorganic Particulates

In one aspect, the inorganic particulate starting materials may include a mineral. In one aspect the inorganic particulate may include silica sand (e.g. silica flour, Ottawa sand, etc.), bauxite, andalusite, alumina, barite, or talc. In another aspect, the granulated inorganic particulate comprises ceramic, porcelain, earthenware, stoneware, brick, glass (e.g., cullet), fly-ash, or slag.

In one aspect, the inorganic particulate can be a mica. The at least one mica may be derived from any one or more of numerous mica production methods, either now known or hereafter discovered. In one aspect, the mica can range in size from about 20 to about 325 mesh, such as for example about 40 to about 140 mesh, or about 50 mesh to about 120 mesh. In another aspect, the mica can range in size from a median particle size (d50) of about 1 micron to about 50 microns (as measured by CILAS), such as for example from about 5 microns to about 15 microns. In one aspect, the mica may be a muscovite mica. In another aspect, the mica may be a phiogopite mica. In yet another aspect, the mica can be a lepidolite, biotite, zinwiadite, clintonite, ilite, phengite, or a hydro-muscovite.

An at least one granulated mica may be prepared by mixing the at least one mica with water in proportions suitable for the desired application. In one embodiment, the granulated mica can be granulated using an Eirich mixer and has a moisture content ranging from 30 wt % to 50 wt %. In another embodiment, the granulated mica can be granulated using a drum pelletizer and has a moisture content ranging from 10 wt % to 30 wt %. In yet another embodiment, the granulated mica is granulated using an Eirich mixer and has a moisture content ranging from 2 wt % to 10 wt %.

The at least one mica slurry may be predispersed. As used herein, “predispersed” means that the at least one mica contains at least one dispersant other than water. In one embodiment, the at least one predispersed mica has a pH of 7 when wetted with fresh water. In another embodiment, the at least one predispersed mica has a pH ranging from 6 to 8 when wetted with fresh water. The at least one dispersant may be chosen from any compound now known or hereafter discovered by the skilled artisan to effect at least one predispersed mica. In one embodiment, the at least one dispersant is chosen from polyacrylate polymers, maleic acrylic polymers, and polyphosphates. In another embodiment, the at least one dispersant is a polyacrylate polymer in the form of sodium polyacrylate. The at least one dispersant may be present in the at least one predispersed mica product in an amount ranging from 0.25 to 2.0 wt % relative to the total weight of the at least one predispersed mica.

In another aspect, the inorganic particulate may be any other plate like or layered mineral. A non-limiting list of other rocks and minerals that may occur in layered (sheet) form includes schist, shale (mudstone), phyllosilicates (sheet silicates), other micas such as fuchsite, sericite, fluoromica, paragonite (“sodium mica”), glauconite, lepidomelane (“iron mica”), and margarite, some forms of some clay minerals such as kaolinite, smectite, pyrophyllite, phengite, montmorillonite, saponite, vermiculite, hectorite, sepiolite, palygorskite (attapulgite), and laponite, sodium silicate hydrates such as kanemite, grumantite, revdite, makatite, magadiite, kenyaite, and octosilicate, serpentine minerals such as antigorite, chrysotile, lizardite, and chrysotile, chlorite, talc, inosilicates, pyroxenoid minerals such as wollastonite, and rhodonite, amphibole minerals such as anthophyllite, tremolite, actinolite, grunerite, amosite, homblende, and diopside, silica, flint (chert), novaculite, kyanite, zeolites (aluminosilicates), hydrotalcite, minerals of the sjogrenite-hydrotalcite group (carbonates), wulfenite (sulfates), asphalts (such as asphalt mesophases), and graphite. Some suitable materials are minerals; some are simply rocks.

The granulated inorganic particulate compositions disclosed herein may further comprise at least one additive. Appropriate additives are those now known or hereafter discovered to have a desired effect on the granulated inorganic particulate composition. In one embodiment, the at least one additive is a binder other than water. Such a binder includes, but is not limited to, carboxy methyl cellulose, hydroxy ethyl cellulose, alginates, gums (e.g., guar gum, xanthan gum, etc.), polyvinyl alcohol, polyvinyl pyrrolidone, and bentonites.

In another embodiment, the at least one additive is a dispersant. Such a dispersant includes, but is not limited to, sodium polyacrylate; soda ash; and, condensed phosphates such as tetra-sodium pyrophosphate, sodium hexametaphosphate, and sodium tripolyphosphate. In a further embodiment, the at least one additive is a dispersant different from the at least one dispersant in the at least one inorganic particulate.

The granulated inorganic particulate compositions may be characterized by their moisture content, as measured in weight percent of the granulated inorganic particulate relative to the total weight of the composition. In one embodiment, the moisture content ranges from 2 wt % to 60 wt %. In one embodiment, the moisture content ranges from 7 wt % to 23 wt %. In another embodiment, the moisture content ranges from 12 wt % to 22 wt %. In a further embodiment, the moisture content ranges from 15 wt % to 21 wt %. In yet another embodiment, the moisture content ranges from 17 wt % to 20 wt %. In yet another embodiment, the moisture content ranges from 2 wt % to 10 wt %. In yet another embodiment, the moisture content ranges from 30 wt % to 50 wt %.

The granulated inorganic particulate compositions may also be characterized by the shape of the granulated inorganic particulate therein, which may be any shape now known or hereafter discovered. In general, the shape of the granulated inorganic particulate is determined by the processing method(s) employed. In one embodiment, the shape is angular. In another embodiment, the shape is sub-angular. In a further embodiment, the shape ranges from angular to sub-angular. In yet another embodiment, the shape is rounded. In yet a further embodiment, the shape is sub-rounded. In still another embodiment, the shape ranges from rounded to sub-rounded. In another embodiment, the shape is approximately spherical. In a further embodiment, the shape is generally determined by the agglomerating method employed.

The granulated inorganic particulate compositions may further be characterized by their particle size when measured in an “as-is” solid or dry state. In one embodiment, less than 5% of the particles are smaller than 10 mesh (2 mm). In another embodiment, a majority of particles (i.e., more than 50%) are 7 mesh (2.83 mm) or larger. In a further embodiment, the average particle size is greater than 10 mesh. In yet another embodiment, the average particle size is greater than 7 mesh. In a further embodiment, the average particle size is greater than 5 mm. In yet another embodiment, the average particle size is greater than 1 cm. In yet a further embodiment, the average particle size ranges from 10 mesh to 0.5 mesh (i.e., from 2 mm to 6.35 mm). In still another embodiment, the average particle size ranges from 10 mesh to 7 mesh.

In one embodiment, the granulated inorganic particulate produced in accordance with the present disclosure (for example, using a pin mill and/or rotary drum) is characterized by a particle size with greater than 20 wt %−20 mesh particles and greater than 70 wt %−12 mesh particles. In another embodiment, the granulated inorganic particulate may be screened after agglomeration (which may also be known as pelletization) to produce a particle size with greater than 30%+12 mesh particles and less than 20%−20 mesh particles. When screening is used in an embodiment of the present invention, any fines removed by screening may be recycled back to the mixing and/or agglomeration stage by any conventional means, such as a belt, bucket pneumatic, or screw conveyor.

In one embodiment, the granulated inorganic particulate compositions of the present disclosure are friable when subjected to a shear force. As used herein, the term “friable” means that when the agglomerates are subjected to a shear force, such as a crushing force, they substantially disintegrate or crumble into a powder, rather than deforming in a plastic manner. In one embodiment, the granulated inorganic particulate composition is friable at a moisture content ranging from 2 to 25 wt %. In one embodiment, the granulated inorganic particulate composition is friable at a moisture content ranging from 10 to 23 wt %. In another embodiment, the granulated inorganic particulate composition is friable at a moisture content ranging from 14 to 20 wt %.

In another embodiment, the process of the present disclosure produces agglomerates that are dough-like in consistency and that deform in a plastic manner, and which do not readily disintegrate into a friable powder when subjected to a shear force (e.g., when they are crushed). In one embodiment, the granulated inorganic particulate composition is dough-like and deform in a plastic manner at a moisture content ranging from 30 to 60 wt %.

In another embodiment, the granulated inorganic particulate compositions of the present disclosure are non-segregating. As used herein, the term “non-segregating” means that the chemical components making up the granulated inorganic particulate composition are mixed into both the granules and any fines that may be present in the composition, such that even if size-based granule segregation occurs (for example, during transport), there is no segregation of the chemical components in the composition.

The granulated inorganic particulate compositions disclosed herein may be particularly beneficial for shipment, in that the agglomerate characteristics disclosed herein may result in a product with a minimal amount of dust and/or a high bulk density. The flowability properties of the granulated inorganic particulate composition may assist in effective storage and/or transportation. The dispersibility of the granulated inorganic particulate composition may allow for a product that easily mixes with water and/or appropriately succumbs to pressure, so as to allow the granulated inorganic particulate composition to disperse into inorganic particulate particles suitable for use in an end product, such as a drilling or fracturing fluid.

### Production Process

The granulated inorganic particulate compositions of the present disclosure may be produced by mixing at least one inorganic particulate with water and a binder, and agglomerating the resulting mixture to form granules.

In one embodiment, the process for producing the granulated inorganic particulate compositions of the present disclosure comprises:
(a) mixing at least one inorganic particulate with water and binder to obtain a desired moisture content; and
(b) agglomerating the resulting mixture to form granules.

In another embodiment, the process of the present disclosure comprises:
(a) mixing at least one inorganic particulate with water and a binder in a first zone of a drum agglomerator; and
(b) agglomerating the resulting mixture to form granules in a second zone of the drum agglomerator.

The process of the present disclosure may be operated in any manner now known or hereafter discovered, for instance, continuous processes and semi-batch processes. The mixing may occur in a low shear mixing environment (such as slow speed paddle mixers and tumblers) or in a high shear mixing environment (such as turbolizers, pin mixers, and plow-shear mixers). The mixture may be granulated in the mixer or in a pelletizer/agglomerator separate from the mixer. In one embodiment, the mixture is granulated in the mixer in which the mixture of the at least one inorganic particulate slurry and the at least one predispersed spray dried inorganic particulate is created. In another embodiment, the mixture is granulated in a pelletizer/agglomerator separate from the mixer in which the mixture of the at least one inorganic particulate, water and binder is created.

Agglomerating may be accomplished using any of a number of devices now known or hereafter discovered for growth agglomeration. In one embodiment, the agglomerator is a pan pelletizer. In another embodiment, the agglomerator is a disc pelletizer. In a further embodiment, the agglomerator is a cone pelletizer. In yet another embodiment, the agglomerator is a drum pelletizer. In yet another embodiment, the agglomerator is an extruder. In one embodiment in which the agglomerator is a drum pelletizer, the at least one inorganic particulate, water and binder are mixed together in a first zone of the drum agglomerator. In that first zone, the nucleation of the mixture to form granules may be initiated by the addition of the water and binder. The mixture, including the newly nucleated granules, may then be fed to a second zone of the drum agglomerator, in which the mixture is brought into contact with itself in a manner such that the mixture adheres to the nucleated granules, causing them to grow in size. In another embodiment in which the agglomerator is a drum agglomerator, the process of the present invention includes at least one step preceding the agglomerating, wherein the water and the at least one spray dried inorganic particulate are premixed together to form a premix that is then transferred to the first zone of the drum agglomerator. In a further embodiment, at least one additional amount of at least one inorganic particulate and water may be added to the mixture or premix in the first zone of the drum pelletizer. In yet another embodiment, agglomerating may be performed at a relative humidity of at least 50%.

Agglomerating may provide any one of several advantages, including strengthening and/or compaction of the pelletized/agglomerated product. Without wishing to be bound by theory, agglomerating is thought to occur via a process wherein the particles are first nucleated and then grow via mechanical action. Water and soluble salts in the water or slurry act as a binder that holds together fundamental particles and particle agglomerates. The water binder is at a level that enables agglomerate particles to crush in a friable manner, not in a plastic manner. That mechanical action may also advantageously act to compact and strengthen the agglomerates. In one embodiment, the process of the present disclosure produces agglomerates that disintegrate into a friable powder when subjected to a shear force (e.g., when they are crushed), rather than deforming in a plastic manner. In another embodiment, the process of the present disclosure produces agglomerates that are dough-like in consistency and that deform in a plastic manner, and which do not readily disintegrate into a friable powder when subjected to a shear force (e.g., when they are crushed).

The form of the granulated inorganic particulate composition may depend in part on the process type and/or equipment used. In one embodiment, in which mixing and granulating occurs in a single stage in a mixer, the granulated inorganic particulate composition comprises a mixture of densified inorganic particulate powder and inorganic particulate granules. In another embodiment, in which mixing and granulating occurs in a high-throughput two-stage process, the granulated inorganic particulate composition comprises a mixture of densified inorganic particulate powder and inorganic particulate granules, with inorganic particulate slurry acting as a binder.

At least one of the mixing step and the agglomerating step may optionally comprise adding at least one of the group consisting of an additional amount of water, an additional amount of the at least one inorganic particulate. Merely for the sake of brevity, and without intending any loss of disclosure or scope, such an additional amount may be called “additional liquid” herein. In one embodiment, the additional inorganic particulate slurry is chosen from low solids slurries of 50 wt % inorganic particulate or less. In another embodiment, the additional inorganic particulate slurry comprises 15 wt % to 50 wt % inorganic particulate. In a further embodiment, the additional inorganic particulate slurry comprises 15 wt % inorganic particulate to 30 wt % inorganic particulate. In yet another embodiment, the additional inorganic particulate slurry is chosen from high solids slurries of 50 wt % inorganic particulate or more.

The at least one additional liquid may be added in any quantity needed to achieve the intended product. In general, too great a quantity will “wet out” and cause the inorganic particulate mixture to become oversaturated with the additional liquid to the point where the inorganic particulate reaches it plastic limit, thus turning into mud. In general, too little a quantity may result in an undesirably higher fines content.

The at least one additional liquid may be added by any means appropriate to add the additional liquid to at least one of the mixing step and the agglomerating step. In one embodiment, the at least one additional liquid is poured into the step. In another embodiment, the at least one additional liquid is added using a controlled spray system with a low viscosity fluid to promote seeding and/or granule growth during agglomeration.

In one embodiment, the components of the controlled spray system are:
(a) A two stage Moyno pump capable of 100 psi, with gauges and shut off valves to restrict and measure flow rates;
(b) A mass flow meter with a 0 to 1 gallon range;
(c) 6 PulsaJet 10000 AUH-10 electric solenoid spray guns mounted on a spray bar capable of a flow rate of one gallon per minute each; and,
(d) an Auto Jet Spray system control unit that can turn the spray guns on and off.
   Various spray tips may be used for the spray guns depending on the spray droplet size desired. In one embodiment, the spray system comprises spray tips that produce droplets of the additional liquid with a size roughly equal to the desired granule size. The pulse duration of the spray guns may, in some embodiments, range from 0.01 seconds to 0.3 seconds.

Following at least one of the mixing step and the agglomeration step, the granulated inorganic particulate composition may optionally undergo at least one screening step. In one embodiment, screening is used to remove fine particles. In another embodiment, screening is used to move −10 mesh particles. In a further embodiment, screening is used to obtain a particularly desirable particle size distribution. If particles are removed by screening, the removed particles may optionally be recycled and added back to the process, for instance, prior to at least one of the mixing step and the agglomeration step.

### Agglomeration System

Further disclosed herein s a system for producing a granulated inorganic particulate composition of the present disclosure, wherein the system comprises:
(a) a first zone for mixing at least one inorganic particulate, water and binder; and
(b) a second zone for agglomerating the resulting mixture to form granules.

In one embodiment, the first and second zones of the system may be substantially the same zone. In another embodiment, the first and second zones may be contained within the same piece of equipment. In a further embodiment, at least one of the first zone and the second zone is a low shear mixer. In yet another embodiment, at least one of the first zone and the second zone is a high shear mixer. In yet a further embodiment, the system of the present disclosure further comprises a third zone for screening the granules to remove fine particles, such as those having a size smaller than 10 mesh. In such an embodiment, the system optionally comprises a means for recycling the fine particles by adding them to at least one of the first zone and the second zone. Appropriate recycling means include any conventional recycling apparatus, including a belt, bucket pneumatic, or screw conveyor.

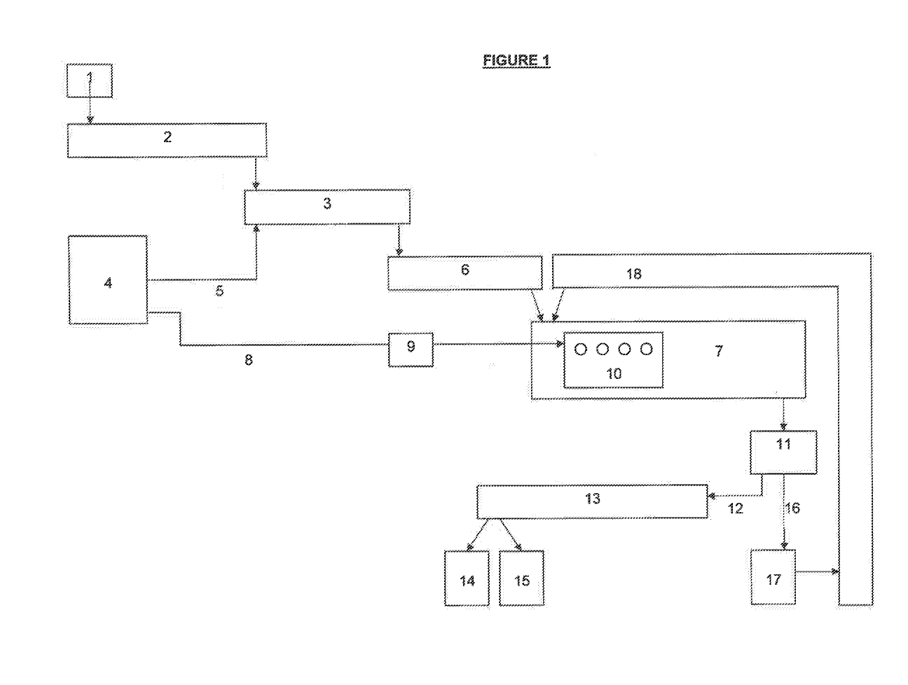

FIG. 1 illustrates one embodiment of a system for producing the disclosed granulated inorganic particulate compositions. An inorganic particulate 1 from a dryer or silo travels upon a belt conveyor 2 to a pin mixer 3. Water and/or binder 4 travels through conduit 5 to the pin mixer 3, where it is mixed with the predispersed spray dried inorganic particulate. The mixture then travels upon a belt conveyor 6 to a drum agglomerator 7. An additional amount of the inorganic particulate slurry or water from tank 4 travels through conduit 8 and electronic spray control 9, such that it is sprayed through spray guns 10 into the drum agglomerator 7. The drum agglomerator mixes the mixture from the pin mixer 3 with the additional amount of inorganic particulate slurry from spray guns 10 and agglomerates the resulting mixture, which is then screened by the 10-mesh screen 11. The desired granulated inorganic particulate composition 12 with an average particle size of 10 mesh or more travels along belt conveyor 13 for storage either in flat store for silo storage 14 or product silo 15. The particles 16 with an average particle size of less than 10 mesh pass to surge bin 17 and then travel along belt conveyor 18 for recycling into the drum agglomerator 7 as part of the mixture from the pin mixer 3 with the additional amount of inorganic particulate slurry or water from spray guns 10.

### Characterization of Granulated Inorganic Particulate

### Angle of Repose

The angle of repose is the acute angle formed between the side of a cone-shaped pile of a material and the horizontal upon which it rests. The flatter the angle, the more flowable the material. Free flowing materials generally have an angle of repose of less than 40 degrees, for example, ranging from 25 to 40 degrees, whereas materials which do not flow freely typically exhibit an angle of repose of 70 degrees or more.

The angle of repose may be measured by placing a sample of material in a funnel with an opening large enough to let the largest particles of the sample through. The test is run by pouring the sample through the funnel onto a solid surface and then, without shaking or vibrating the surface, measuring (with a protractor or other suitable measuring device) the angle the cone-like pile forms with the horizontal.

The granulated inorganic particulate compositions may be characterized by their angle of repose. In one embodiment, the angle of repose ranges from 10 to 55 degrees. In another embodiment, the angle of repose ranges from about 15 to about 25 degrees. In another embodiment, the angle of repose ranges from about 18 to about 23 degrees. In a further embodiment, the angle of repose is low enough that the desired bulk density of the granulated inorganic particulate composition is achieved, but high enough to allow for the granulated inorganic particulate composition to flow through desired and/or necessary openings and channels for effective storage and shipment.

### Packed Bulk Density

Packed bulk density is determined by measuring the weight of a product filing a standard volume, after tapping the sample to remove air between the particles. The packed bulk density may be measured by placing a sample of material having a known weight into a graduated cylinder, tapping or vibrating the sample multiple times for a given period of time, and then measuring the volume taken up by the sample. Bulk density can then be calculated simply as weight divided by volume.

The granulated inorganic particulate compositions may be characterized by their packed bulk density. In one embodiment, the packed bulk density ranges from 0.5 to 1.5 gm/cm³. In another embodiment, the packed bulk density ranges from 0.6 to 0.8 g/cm³.

### Compressibility

Compressibility may be correlated to the behavior of a material in a static state (e.g., in a silo). If the compressibility is low, for example, less than about 20%, the product flows freely. If the compressibility is high, for instance, greater than about 40%, the product packs and has a tendency to agglomerate in the static state.

The percent compressibility of a material may be defined by the following formula:

$$\frac{( packed bulk density - aerated bulk density ) \times 100}{packed bulk density}$$

The measurements of packed bulk density and aerated bulk density may be calculated by standard methods using a Hosokawa micron powder tester. In one embodiment, the granulated inorganic particulate composition has a percent compressibility of less than 20%. In another embodiment, the percent compressibility is less than 19%. In a further embodiment, the percent compressibility is less than 16%.

### Cohesiveness

Cohesiveness is a measure of the amount of energy required to pull apart agglomerates of particles in a specified time. Cohesiveness may be correlated to the behavior of material in the dynamic state. Low cohesiveness, for example, 20% or less, reflects a material's ability to flow easily in transfer systems (e.g., improved flowability and floodability). High cohesiveness, for example, greater than 20%, may lead to material blockage or clogging in the transfer system. The measurements may be calculated using a Hosokawa micron powder tester.

### Dispersibility

Dispersibility is an Indication of the ease with which a material may be made down into a slurry. If the index for dispersibility is greater than 50%, for example, the material be prone to flushing. In one embodiment, the dispersibility index is at least 10%. In another embodiment, the dispersibility index is at least 15%. In a further embodiment, the dispersibility index is at least 20%. In yet another embodiment, the dispersibility index is less than 50%. In yet a further embodiment, the dispersibility index is less than 30%. In still another embodiment, the dispersibility index is less than 20%.

Other than in the examples, or where otherwise indicated, all numbers expressing quantities of Ingredients, reaction conditions, and so forth used in the specification and claims are to be understood as being modified in all instances by the term “about” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, unless otherwise indicated the numerical values set forth in the specific examples are reported as precisely as possible. Any numerical value, however, inherently contains certain errors necessarily resulting from the standard deviation found in their respective testing measurements.

By way of non-limiting illustration, examples of certain embodiments of the present disclosure are given below.

### Example 1

A Minelco phlogopite mica was sandground in a lab sandgrinder with an total energy input of 500 kwh/T to produce a mica having a d50 of 9 microns (by CILAS). 2000 g of this mica was granulated with 1 wt % Unibond Polyvinyl Acetate and 23% water using an Eirich mixer at 2700 rpm and at an angle of 32°. The resulting granules had a granule size of 72%+1000 microns, 15%−1000 micron to +710 microns, and 13%−710 micron. The granules produced were dried at 80 degrees C. for 10 hrs.

When added to water, the above granules did not immediately break down. However, they were found to be fully dispersed after approximately 24 hrs had elapsed. It is hypothesized that the granules resistance to immediate redispersion is likely a consequence of the low solubility of PVA in water.

### Example 2

Sample 2 was prepared by granulating 1000 g of Suzorite 40/140 mesh mica with 0.3 wt % carboxymethylcellulose (Finnfix 5, available from CP Kelco, Atlanta, Ga., USA) as a binder and with 7.9% by weight water. The mica, binder and water were first pre-mixed in an Eirich mixer at 2700 rpm and at an angle of 32°, and then granulated using a pan pelletizer having a diameter of 43 cm at an angle of 32 degrees at 40 rpm. The granules produces had a broad range of sized ranging from approximately 1 cm down to 200 microns with no appreciable dust. The granules produced were dried at 80 degrees C. for 10 hrs.

When added to water, the above granules were observed to immediately break down and fully disperse.

### Example 3

Sample 3 was prepared by granulating 2500 g of Suzorite 40/140 mesh mica with 1.0 wt % carboxymethylcellulose (Finnfix 10, available from CP Kelco, Atlanta, Ga., USA) as a binder and with 11% water. The mica, binder and water were first pre-mixed in an Eirich mixer at 2700 rpm and at an angle of 32°, and then granulated using a pan pelletizer having a diameter of 43 cm at an angle of 32 degrees at 40 rpm. The granules produced had a broad range of sized ranging from approximately 1 cm down to 200 microns with no appreciable dust. The granules produced were dried at 80 degrees C. for 10 hrs.

Prior to granulation, the Suzorite mica had a packed bulk density of 0.64 g/cm³ and an angle of repose of 28 degrees. After granulation, the packed bulk density of the granulated mica was 0.76 g/cm³. and the angle of repose ranged from 18 to 23 degrees. When added to water, the above granules were observed to immediately break down and fully disperse.

For the avoidance of doubt, the subject-matter of the present invention includes the subject-matter as defined in the following numbered paragraphs.

1. A granulated inorganic particulate composition for use in oil field applications comprising:

a inorganic particulate having an average particle size less than about 20 mesh;

0.01% to about 1.0% of a water soluble binder;

wherein said granulated inorganic particulate composition has an average granule size greater than about 20 mesh.

2. The granulated inorganic particulate composition of paragraph 1, wherein said inorganic particulate comprises a material selected from silica sand (e.g. silica flour, Ottawa sand, etc.), bauxite, andalusite, alumina, barite, or talc.

3. The granulated inorganic particulate composition of paragraph 1, wherein said inorganic particulate comprises a material selected from ceramic, porcelain, earthenware, stoneware, brick, glass (e.g., cullet), fly-ash, or slag.

4. The granulated inorganic particulate composition of paragraph 1, wherein said inorganic particulate comprises mica.

5. The granulated inorganic particulate composition of paragraph 1, wherein said inorganic particulate comprises a plate like mineral.

6. The granulated inorganic particulate composition of paragraph 1, wherein said plate like mineral is selected schist, shale (mudstone), phyllosilicates (sheet silicates), glauconite, kaolinite, smectite, pyrophyllite, phengite, montmorillonite, saponite, vermiculite, hectorite, sepiolite, palygorskite (attapulgite), and laponite, a sodium silicate hydrates (such as kanemite, grumantite, revdite, makatite, magadiite, kenyaite, and octosilicate), a serpentine mineral (such as antigorite, chrysotile, lizardite, and chrysotile), chlorite, talc, inosilicates, pyroxenoid minerals (such as wollastonite, and rhodonite), amphibole minerals (such as anthophyllite, tremolite, actinolite, grunerite, amosite, homblende, and diopside), silica, flint (chert), novaculite, kyanite, zeolites (aluminosilicates), hydrotalcite, minerals of the sjogrenite-hydrotalcite group (carbonates), wulfenite (sulfates), asphalts (such as asphalt mesophases), and graphite.

7. The granulated inorganic particulate composition of paragraph 1, wherein said inorganic particulate has an average particle size ranging from about 20 mesh to about 500 mesh.

8. The granulated inorganic particulate composition of paragraph 1, wherein said inorganic particulate has an average particle size ranging from about 20 mesh to about 325 mesh.

9. The granulated inorganic particulate composition of paragraph 1, wherein said inorganic particulate has an average particle size ranging from about 40 mesh to about 140 mesh.

10. The granulated inorganic particulate composition of paragraph 1, wherein said inorganic particulate has a CILAS median particle size (d50) ranging from about 1 micron to about 50 microns.

11. The granulated inorganic particulate composition of paragraph 1, wherein said inorganic particulate has CILAS median particle size (d50) ranging from about 5 microns to about 15 microns.

12. The granulated inorganic particulate composition of paragraph 1, wherein said binder is present in an amount ranging from about 0.1% to about 0.5%.

13. The granulated inorganic particulate composition of paragraph 1, wherein said binder is present in an amount ranging from about 0.5% to about 10%.

14. The granulated inorganic particulate composition of paragraph 1, wherein said binder comprises a material selected from hydroxy ethyl cellulose, alginates, guar gum, polyvinyl alcohol, polyvinyl pyrrolidone, and bentonites.

15. The granulated inorganic particulate composition of paragraph 1, wherein said binder comprises carboxymethyl cellulose.

16. The granulated inorganic particulate composition of paragraph 1, wherein said granulated inorganic particulate has a moisture content ranging from about 5% to about 25%.

17. The granulated inorganic particulate composition of paragraph 1, wherein the composition has an angle of repose ranging from about 15 to about 25 degrees.

18. The granulated inorganic particulate composition of paragraph 1, wherein the composition has a packed bulk density ranging from about 0.5 g/cm³ to about 1.5 g/cm³.

19. The granulated inorganic particulate composition of paragraph 1, wherein the composition has an average particle size of greater than about 12 mesh.

20. The granulated inorganic particulate composition of paragraph 1, wherein the composition has an average particle size of greater than about 10 mesh.

21. The granulated inorganic particulate composition of paragraph 1, wherein the composition has an average particle size of greater than about 7 mesh.

22. The granulated inorganic particulate composition of paragraph 1, wherein the composition has an average particle size ranging from about 10 mesh to about 7 mesh.

23. The granulated inorganic particulate composition of paragraph 1, wherein the composition has a shape selected from angular or sub angular.

24. The granulated inorganic particulate composition of paragraph 1, wherein the composition has a Krumbein sphericity of at least about 0.8.

25. The granulated inorganic particulate composition of paragraph 1, wherein the composition is friable when subjected to a shear force.

26. The granulated inorganic particulate composition of paragraph 1, wherein the composition is not friable when subjected to a shear force.

27. The granulated inorganic particulate composition of paragraph 1, further comprising a dispersant.

28. The granulated inorganic particulate composition of paragraph 27, wherein the dispersant is selected from: sodium polyacrylate; soda ash; and condensed phosphates such as tetra-sodium pyrophosphate, sodium hexametaphosphate, and sodium tripolyphosphate.

29. A granulated mica composition comprising:

mica having an average particle size less than about 20 mesh;

0.01% to about 1.0% of a water soluble binder;

wherein said granulated mica composition has a granule size greater than about 20 mesh.

30. The granulated mica composition of paragraph 29, wherein said mica comprises muscovite.

31. The granulated mica composition of paragraph 29, wherein said mica comprises phlogopite.

32. The granulated mica composition of paragraph 29, wherein said mica comprises a material selected from lepidolite, biotite, zinwiadite, clintonite, illite, phengite, and hydro-muscovite.

33. The granulated mica composition of paragraph 29, wherein said mica has an average particle size ranging from about 20 mesh to about 500 mesh.

34. The granulated mica composition of paragraph 29, wherein said mica has an average particle size ranging from about 20 mesh to about 325 mesh.

35. The granulated mica composition of paragraph 29, wherein said mica has an average particle size ranging from about 40 mesh to about 140 mesh.

36. The granulated mica composition of paragraph 29, wherein said mica has an average particle size ranging from about has a CILAS median particle size (d50) ranging from about 1 micron to about 50 microns.

37. The granulated mica composition of paragraph 29, wherein said mica has an average particle size ranging from about has a CILAS median particle size (d50) ranging from about 5 microns to about 15 microns.

38. The granulated mica composition of paragraph 29, wherein said binder is present in an amount ranging from about 0.1% to about 10%.

39. The granulated mica composition of paragraph 29, wherein said binder is present in an amount ranging from about 0.1% to about 0.5%.

40. The granulated mica composition of paragraph 29, wherein said binder comprises a material selected from hydroxy ethyl cellulose, alginates, polyvinyl alcohol, polyvinyl pyrrolidone, and bentonites.

41. The granulated mica composition of paragraph 29, wherein said binder comprises carboxymethyl cellulose.

42. The granulated mica composition of paragraph 29, wherein said granulated mica has a moisture content ranging from about 5% to about 25%.

43. The granulated mica composition of paragraph 29, wherein the composition has an angle of repose ranging from about 15 to about 25 degrees.

44. The granulated mica composition of paragraph 29, wherein the composition has a packed bulk density ranging from about 0.5 g/cm³ to about 1.5 g/cm³.

45. The granulated mica composition of paragraph 29, wherein the composition has an average particle size of greater than about 12 mesh.

46. The granulated mica composition of paragraph 29, wherein the composition has an average particle size of greater than about 10 mesh.

47. The granulated mica composition of paragraph 29, wherein the composition has an average particle size of greater than about 7 mesh.

48. The granulated mica composition of paragraph 29, wherein the composition has an average particle size ranging from about 10 mesh to about 7 mesh.

49. The granulated mica composition of paragraph 29, wherein the composition is friable when subjected to a shear force.

50. The granulated mica composition of paragraph 29, further comprising a dispersant.

51. The granulated mica composition of paragraph 50, wherein the dispersant is selected from: sodium polyacrylate; soda ash; and condensed phosphates such as tetra-sodium pyrophosphate, sodium hexametaphosphate, and sodium tripolyphosphate.

52. A process for producing a granulated inorganic particulate composition for use in oil field applications, comprising:
(a) mixing at least one inorganic particulate having an average particle size of less than about 20 mesh with water and at least one binder; and
(b) agglomerating the resulting mixture to form a granulated inorganic particulate having an average particle size of greater than about 20 mesh.

53. The process of paragraph 51, wherein the mixing step and optionally the agglomerating step occurs in a mixer chosen from a low shear mixer and a high shear mixer.

54. The process of paragraph 51, wherein the low shear mixer is chosen from a slow speed paddle mixer and a tumbler.

55. The process of paragraph 51, wherein the high shear mixer is chosen from a turbolizer, a pin mixer, and a plow-shear mixer.

56. The process of paragraph 51, wherein the agglomerating occurs in a pelletizer chosen from a pan pelletizer, a disc pelletizer, a cone pelletizer, and a drum pelletizer.

57. The process of paragraph 51, wherein the agglomerating occurs in an extruder.

58. The process of paragraph 51, further comprising screening the granules to remove fine particles having a size smaller than 10 mesh.

59. The process of paragraph 51, further comprising recycling the fine particles by adding them to at least one of the mixing step and the agglomerating step.

60. The process of paragraph 51, wherein the process is chosen from a continuous process and a semi-batch process.

61. The process of paragraph 51, further including drying the granules to remove at least a portion of the water therefrom.

62. The process of paragraph 51, wherein said inorganic particulate comprises a material selected from silica sand (e.g. silica flour, Ottawa sand, etc.), bauxite, andalusite, alumina, barite, or talc.

63. The process of paragraph 51, wherein said inorganic particulate comprises a material selected from ceramic, porcelain, earthenware, stoneware, brick, glass (e.g., cullet), fly-ash, or slag.

64. The process of paragraph 51, wherein said inorganic particulate comprises mica.

65. The process of paragraph 51, wherein said inorganic particulate comprises a plate like mineral.

66. The process of paragraph 51, wherein said plate like mineral is selected schist, shale (mudstone), phyllosilicates (sheet silicates), glauconite, kaolinite, smectite, pyrophyllite, phengite, montmorillonite, saponite, vermiculite, hectorite, sepiolite, palygorskite (attapulgite), and laponite, a sodium silicate hydrates (such as kanemite, grumantite, revdite, makatite, magadiite, kenyalte, and octosilicate), a serpentine mineral (such as antigorite, chrysotile, lizardite, and chrysotile), chlorite, talc, inosilicates, pyroxenoid minerals (such as wollastonite, and rhodonite), amphibole minerals (such as anthophyllite, tremolite, actinolite, grunerite, amosite, homblende, and diopside), silica, flint (chert), novaculite, kyanite, zeolites (aluminosilicates), hydrotalcite, minerals of the sjogrenite-hydrotalcite group (carbonates), wulfenite (sulfates), asphalts (such as asphalt mesophases), and graphite.

67. The process of paragraph 51, wherein said inorganic particulate has an average particle size ranging from about 20 mesh to about 500 mesh.

68. The process of paragraph 51, wherein said inorganic particulate has an average particle size ranging from about 20 mesh to about 325 mesh.

69. The process of paragraph 51, wherein said inorganic particulate has an average particle size ranging from about 40 mesh to about 140 mesh.

70. The process of paragraph 51, wherein said inorganic particulate has a CILAS median particle size (d50) ranging from about 1 micron to about 50 microns.

71. The process of paragraph 51, wherein said inorganic particulate has CILAS median particle size (d50) ranging from about 5 microns to about 15 microns.

72. The process of paragraph 51, wherein said binder is present in an amount ranging from about 0.1% to about 0.5%.

73. The process of paragraph 51, wherein said binder is present in an amount ranging from about 0.5% to about 10%.

74. The process of paragraph 51, wherein said binder comprises a material selected from hydroxy ethyl cellulose, alginates, guar gum, polyvinyl alcohol, polyvinyl pyrrolidone, and bentonites.

75. The process of paragraph 51, wherein said binder comprises carboxymethyl cellulose.

76. The process of paragraph 51, wherein said granulated inorganic particulate has a moisture content ranging from about 5% to about 25%.

77. The process of paragraph 51, wherein the granulated inorganic particulate has an angle of repose ranging from about 15 to about 25 degrees.

78. The process of paragraph 51, wherein the granulated inorganic particulate has a packed bulk density ranging from about 0.5 g/cm³ to about 1.5 g/cm³.

79. The process of paragraph 51, wherein the granulated inorganic particulate has an average particle size of greater than about 12 mesh.

80. The process of paragraph 51, wherein the granulated inorganic particulate has an average particle size of greater than about 10 mesh.

81. The process of paragraph 51, wherein the granulated inorganic particulate has an average particle size of greater than about 7 mesh.

82. The process of paragraph 51, wherein the granulated inorganic particulate has an average particle size ranging from about 10 mesh to about 7 mesh.

83. The process of paragraph 51, wherein the granulated inorganic particulate is friable when subjected to a shear force.

84. The process of paragraph 51, wherein the granulated inorganic particulate is not friable when subjected to a shear force.

85. The process of paragraph 51, further comprising a dispersant.

86. The process of paragraph 85, wherein the dispersant is selected from: sodium polyacrylate; soda ash; and condensed phosphates such as tetra-sodium pyrophosphate, sodium hexametaphosphate, and sodium tripolyphosphate.

87. A granulated inorganic particulate composition for use in oil field applications comprising:

a inorganic particulate having an average particle size less than about 12 mesh; and

0.01% to about 1.0% of a water soluble binder;

wherein said granulated inorganic particulate composition has a granule size greater than about 12 mesh.

88. The granulated inorganic particulate composition of paragraph 87, wherein said inorganic particulate comprises a material selected from silica sand (e.g. silica flour, Ottawa sand, etc.), bauxite, andalusite, alumina, barite, or talc.

89. The granulated inorganic particulate composition of paragraph 87, wherein said inorganic particulate comprises a material selected from ceramic, porcelain, earthenware, stoneware, brick, glass (e.g., cullet), fly-ash, or slag.

90. The granulated inorganic particulate composition of paragraph 87, wherein said inorganic particulate comprises mica.

91. The granulated inorganic particulate composition of paragraph 87, wherein said inorganic particulate comprises a plate like mineral.

92. The granulated inorganic particulate composition of paragraph 87, wherein said plate like mineral is selected schist, shale (mudstone), phyllosilicates (sheet silicates), glauconite, kaolinite, smectite, pyrophyllite, phengite, montmorillonite, saponite, vermiculite, hectorite, sepiolite, palygorskite (attapulgite), and laponite, a sodium silicate hydrates (such as kanemite, grumantite, revdite, makatite, magadiite, kenyaite, and octosilicate), a serpentine mineral (such as antigorite, chrysotile, lizardite, and chrysotile), chlorite, talc, inosilicates, pyroxenoid minerals (such as wollastonite, and rhodonite), amphibole minerals (such as anthophyllite, tremolite, actinolite, grunerite, amosite, homblende, and diopside), silica, flint (chert), novaculite, kyanite, zeolites (aluminosilicates), hydrotalcite, minerals of the sjogrenite-hydrotalcite group (carbonates), wulfenite (sulfates), asphalts (such as asphalt mesophases), and graphite.

93. The granulated inorganic particulate composition of paragraph 87, wherein said inorganic particulate has an average particle size ranging from about 20 mesh to about 500 mesh.

94. The granulated inorganic particulate composition of paragraph 87, wherein said inorganic particulate has an average particle size ranging from about 20 mesh to about 325 mesh.

95. The granulated inorganic particulate composition of paragraph 87, wherein said inorganic particulate has an average particle size ranging from about 40 mesh to about 140 mesh.

96. The granulated inorganic particulate composition of paragraph 87, wherein said inorganic particulate has a CILAS median particle size (d50) ranging from about 1 micron to about 50 microns.

97. The granulated inorganic particulate composition of paragraph 87, wherein said inorganic particulate has CILAS median particle size (d50) ranging from about 5 microns to about 15 microns.

98. The granulated inorganic particulate composition of paragraph 87, wherein said binder is present in an amount ranging from about 0.1% to about 0.5%.

99. The granulated inorganic particulate composition of paragraph 87, wherein said binder is present in an amount ranging from about 0.5% to about 10%.

100. The granulated inorganic particulate composition of paragraph 87, wherein said binder comprises a material selected from hydroxy ethyl cellulose, alginates, guar gum, polyvinyl alcohol, polyvinyl pyrrolidone, and bentonites.

101. The granulated inorganic particulate composition of paragraph 87, wherein said binder comprises carboxymethyl cellulose.

102. The granulated inorganic particulate composition of paragraph 87, wherein said granulated inorganic particulate has a moisture content ranging from about 5% to about 25%.

103. The granulated inorganic particulate composition of paragraph 87, wherein the composition has an angle of repose ranging from about 15 to about 25 degrees.

104. The granulated inorganic particulate composition of paragraph 87 wherein the composition has a packed bulk density ranging from about 0.5 g/cm³ to about 1.5 g/cm³.

105. The granulated inorganic particulate composition of paragraph 87, wherein the composition has an average particle size of greater than about 12 mesh.

106. The granulated inorganic particulate composition of paragraph 87, wherein the composition has an average particle size of greater than about 10 mesh.

107. The granulated inorganic particulate composition of paragraph 87, wherein the composition has an average particle size of greater than about 7 mesh.

108. The granulated inorganic particulate composition of paragraph 87, wherein the composition has an average particle size ranging from about 10 mesh to about 7 mesh.

109. The granulated inorganic particulate composition of paragraph 87, wherein the composition has a shape selected from angular or sub angular.

110. The granulated inorganic particulate composition of paragraph 87, wherein the composition has a Krumbein sphericity of at least about 0.8.

111. The granulated inorganic particulate composition of paragraph 87, wherein the composition is friable when subjected to a shear force.

112. The granulated inorganic particulate composition of paragraph 87, wherein the composition is not friable when subjected to a shear force.

113. The granulated inorganic particulate composition of paragraph 87, further comprising a dispersant.

114. The granulated inorganic particulate composition of paragraph 113, wherein the dispersant is selected from: sodium polyacrylate; soda ash; and condensed phosphates such as tetra-sodium pyrophosphate, sodium hexametaphosphate, and sodium tripolyphosphate.

115. A method for treating a subterranean formation comprising:

providing a granulated inorganic particulate composition having an average granule size of at least about 20 mesh,

admixing the granulated inorganic particle composition into a fluid, such that the inorganic particulate is dispersed into the fluid as a suspended inorganic particulate, and

injecting the fluid and suspended inorganic particulate into the subterranean formation.

116. The method of paragraph 115, further comprising depositing the suspended particulate into a fracture in the subterranean formation.

117. The granulated inorganic particulate composition of paragraph 115 wherein said inorganic particulate comprises a material selected from silica sand (e.g. silica flour, Ottawa sand, etc.), bauxite, andalusite, alumina, barite, or talc.

118. The granulated inorganic particulate composition of paragraph 115, wherein said inorganic particulate comprises a material selected from ceramic, porcelain, earthenware, stoneware, brick, glass (e.g., cullet), fly-ash, or slag.

119. The granulated inorganic particulate composition of paragraph 115, wherein said inorganic particulate comprises mica.

120. The granulated inorganic particulate composition of paragraph 115, wherein said inorganic particulate comprises a plate like mineral.

121. The granulated inorganic particulate composition of paragraph 115, wherein said plate like mineral is selected schist, shale (mudstone), phyllosilicates (sheet silicates), glauconite, kaolinite, smectite, pyrophyllite, phengite, montmorillonite, saponite, vermiculite, hectorite, sepiolite, palygorskite (attapulgite), and laponite, a sodium silicate hydrates (such as kanemite, grumantite, revdite, makatite, magadiite, kenyaite, and octosilicate), a serpentine mineral (such as antigorite, chrysotile, lizardite, and chrysotile), chlorite, talc, inosilicates, pyroxenoid minerals (such as wollastonite, and rhodonite), amphibole minerals (such as anthophyllite, tremolite, actinolite, grunerite, amosite, homblende, and diopside), silica, flint (chert), novaculite, kyanite, zeolites (aluminosilicates), hydrotalcite, minerals of the sjogrenite-hydrotalcite group (carbonates), wulfenite (sulfates), asphalts (such as asphalt mesophases), and graphite.

122. The granulated inorganic particulate composition of paragraph 115, wherein said inorganic particulate has an average particle size ranging from about 20 mesh to about 500 mesh.

123. The granulated inorganic particulate composition of paragraph 115, wherein said inorganic particulate has an average particle size ranging from about 20 mesh to about 325 mesh.

124. The granulated inorganic particulate composition of paragraph 115, wherein said inorganic particulate has an average particle size ranging from about 40 mesh to about 140 mesh.

125. The granulated inorganic particulate composition of paragraph 115, wherein said inorganic particulate has a CILAS median particle size (d50) ranging from about 1 micron to about 50 microns.

126. The granulated inorganic particulate composition of paragraph 115, wherein said inorganic particulate has CILAS median particle size (d50) ranging from about 5 microns to about 15 microns.

127. The granulated inorganic particulate composition of paragraph 115, further including a binder, wherein said binder is present in an amount ranging from about 0.1% to about 0.5%.

128. The granulated inorganic particulate composition of paragraph 127, wherein said binder is present in an amount ranging from about 0.5% to about 10%.

129. The granulated inorganic particulate composition of paragraph 127, wherein said binder comprises a material selected from hydroxy ethyl cellulose, alginates, guar gum, polyvinyl alcohol, polyvinyl pyrrolidone, and bentonites.

130. The granulated inorganic particulate composition of paragraph 127, wherein said binder comprises carboxymethyl cellulose.

131. The granulated inorganic particulate composition of paragraph 115, wherein said granulated inorganic particulate has a moisture content ranging from about 5% to about 25%.

132. The granulated inorganic particulate composition of paragraph 115, wherein the composition has an angle of repose ranging from about 15 to about 25 degrees.

133. The granulated inorganic particulate composition of paragraph 115, wherein the composition has a packed bulk density ranging from about 0.5 g/cm³ to about 1.5 g/cm³.

134. The granulated inorganic particulate composition of paragraph 115, wherein the composition has an average particle size of greater than about 12 mesh.

135. The granulated inorganic particulate composition of paragraph 115, wherein the composition has an average particle size of greater than about 10 mesh.

136. The granulated inorganic particulate composition of paragraph 115, wherein the composition has an average particle size of greater than about 7 mesh.

137. The granulated inorganic particulate composition of paragraph 115, wherein the composition has an average particle size ranging from about 10 mesh to about 7 mesh.

138. The granulated inorganic particulate composition of paragraph 115, wherein the composition has a shape selected from angular or sub angular.

139. The granulated inorganic particulate composition of paragraph 115, wherein the composition has a Krumbein sphericity of at least about 0.8.

140. The granulated inorganic particulate composition of paragraph 115, wherein the composition is friable when subjected to a shear force.

141. The granulated inorganic particulate composition of paragraph 115, wherein the composition is not friable when subjected to a shear force.

142. The granulated inorganic particulate composition of paragraph 115, further comprising a dispersant.

143. The granulated inorganic particulate composition of paragraph 142, wherein the dispersant is selected from: sodium polyacrylate; soda ash; and condensed phosphates such as tetra-sodium pyrophosphate, sodium hexametaphosphate, and sodium tripolyphosphate.

1-143. (canceled)

144. A method for treating a subterranean formation comprising:
providing a granulated inorganic particulate composition having an average granule size of at least about 20 mesh;
admixing the granulated inorganic particle composition into a fluid, such that the inorganic particulate is dispersed into the fluid as a suspended inorganic particulate; and
injecting the fluid and suspended inorganic particulate into the subterranean formation.

145. The method of claim 144, further comprising depositing the suspended inorganic particulate into a fracture in the subterranean formation.

146. The method of claim 144, wherein the granulated inorganic particulate composition comprises an inorganic particulate having an average particle size ranging from about 20 mesh to about 500 mesh.

147. The method of claim 144, wherein the granulated inorganic particulate composition has an average particle size of greater than about 12 mesh.

148. The method of claim 144, wherein said granulated inorganic particulate composition comprises mica particulate.

149. The method of claim 144, wherein said granulated inorganic particulate composition comprises a material selected from silica sand, bauxite, andalusite, alumina, barite, or talc.

150. The method of claim 144, wherein said granulated inorganic particulate composition comprises a material selected from ceramic, porcelain, earthenware, stoneware, brick, glass, fly-ash, or slag.

151. The method of claim 144, wherein said granulated inorganic particulate composition comprises a plate like mineral.

152. The method of claim 151, wherein the plate like mineral is selected from schist, shale, phyllosilicates, glauconite, kaolinite, smectite, pyrophyllite, phengite, montmorillonite, saponite, vermiculite, hectorite, sepiolite, palygorskite, and laponite, a sodium silicate hydrates, a serpentine mineral, chlorite, talc, inosilicates, pyroxenoid minerals, amphibole minerals, silica, flint, novaculite, kyanite, zeolites, hydrotalcite, minerals of the sjogrenite-hydrotalcite group, wulfenite, asphalts, and graphite.

153. The method of claim 144, wherein said granulated inorganic particulate composition comprises an inorganic particulate having a CILAS median particle size (d50) ranging from about 1 micron to about 50 microns.

154. The method of claim 144, further including providing a binder, wherein said binder is present in an amount ranging from about 0.1% to about 10%.

155. The method of claim 154, further including providing a binder, wherein said binder is present in an amount ranging from about 0.1% to about 0.5%.

156. The method of claim 154, wherein said binder comprises a material selected from hydroxy ethyl cellulose, alginates, guar gum, polyvinyl alcohol, polyvinyl pyrrolidone, bentonites, and carboxymethyl cellulose.

157. The method of claim 144, wherein said granulated inorganic particulate composition has a moisture content ranging from about 5% to about 25%.

158. The method of claim 144, wherein the granulated inorganic particulate composition has an angle of repose ranging from about 15 to about 25 degrees.

159. The method of claim 144, wherein the granulated inorganic particulate composition has a packed bulk density ranging from about 0.5 g/cm³ to about 1.5 g/cm³.

160. The method of claim 144, wherein the granulated inorganic particulate composition comprises an inorganic particulate having a shape selected from angular or sub angular.

161. The method of claim 144, wherein the granulated inorganic particulate composition comprises inorganic particulate granules having a Krumbein sphericity of at least about 0.8.

162. The method of claim 144, further comprising providing a dispersant.

163. The method of claim 162, wherein the dispersant is selected from sodium polyacrylate, soda ash, and condensed phosphates.
